(19) United States
(12) Patent Application Publication
(10) Pub. No.: US 2007/0109130 A1
(43) Pub. Date: May 17, 2007

(54) Card cases and wallets with radio frequency shielding

(76) Inventor: Benjamin W. Edenfield, Atlanta, GA (US)

Correspondence Address: James C. Wray, Suite 300, 1493 Chain Bridge Road, McLean, VA, 22101, US

(21) Appl. No.: 11/281,543

(22) Filed: Nov. 17, 2005

(51) Int. Cl. G08B 13/14; H01Q 1/52

(52) U.S. Cl. 340/572.8; 340/572.7; 343/841

(57) ABSTRACT

A portable enclosure has a hinged or slide opening capable of containing several RFID tags embedded in other devices. The present invention provides two layer portable enclosures. The inner layer is a protective layer that keeps signals from hitting the RFID tags. The outer layer is a physical barrier against the elements and serves a decorative function. The inner layer metal is preferably, but not limited to, copper, silver, aluminum, tin or any other metal capable of attenuating completely the wavelength necessary to reach and activate the embedded RFID tag. The metal may be in a weave, solid or any other structure capable of the necessary shielding. The outer layer is made of materials capable of withstanding use, weather, and the surrounding environment. The inner layer may be embedded within the outer layer. A wallet is made of shielding material with flaps surrounding the devices with embedded RFID.

### FIELD OF THE INVENTION

The present invention relates to the field of radio frequency electromagnetic signal shielding for contactless cards.

### BACKGROUND OF THE INVENTION

Contactless cards are widely used. An estimated distribution adds more than one billion cards per year. Contactless cards interact with and receive power from contactless readers by fine wire or printed antennas embedded in the cards. The antennas are connected to micro circuit chips and memories within the cards. Contactless payment devices are usually read within short distances of a few inches. Contactless radio frequency identification cards are designed to be read at larger distances.

Radio frequency electromagnetic signal technology uses wireless communication of signals in radio frequency bands to power and transmit data from contactless tags to contactless cards and readers. A tag or chips and an antenna are attached to or embedded in an object to be identified. A contactless reader powers and scans the tag or chip for data and sends the information to a database, which stores the data contained on the tag, chip or attached memory.

Interest in contactless RFID technology has been increasing rapidly. Contactless technology offers several improvements over its predecessor technologies, such as machine readable contact chips, barcodes and magnetic stripe cards. An RFID tag, chip or memory carries more data than a barcode or magnetic stripe and can be reprogrammed with new information if needed. Additionally, contactless tags, chips or memories do not typically require a line of light to be read, as barcodes do, and can be read more rapidly and over greater distances. Contactless RFID technology is now being used in a variety of public and private-sector settings.

However, there are several drawbacks to RFID technology as it currently exists. Specifically, these drawbacks include ensuring that only authorized readers or personnel have access to information. Identity and other information theft issues may become increasingly common as contactless RFID technology is integrated into important personal documents, such as credit cards, passports and other documents. Without effective security controls, data on the tag, chips and memories can be read by any compliant contactless reader. Furthermore, data transmitted through the air can be intercepted and read by unauthorized devices and individuals.

Current methods of reducing unwanted access to contactless RFID technology information include wrapping RFID devices in Aluminum foil or placing the contactless RFID devices in Aluminum-Mylar bags.

When using Aluminum foil, the foil must be replaced often. It is difficult to unwrap and reuse foil regularly. It is also difficult to place a foil wrapped credit card in a wallet. The appearance of a foil wrapped credit card or passport is not visually appealing and may arouse suspicion from customs officials or produce an alarm in a metal detector. Furthermore, if the foil is not wrapped well, RF/EM signals may reach the contactless RFID device, defeating the purpose of wrapping the RFID device.

Mylar bags are more durable than Aluminum foil. However, Mylar bags still carry the risk of insufficient closure or potential for opening during transport. Mylar bags are also susceptible to being cut, thus eliminating any protection.

Other RFID shielding solutions are not readily portable and may not be useful for contactless RFID technology in personal devices. Non-portable RFID shielding devices attach directly to electronics and do not completely surround the item to be protected.

Needs exist for improved methods for storing and transporting valuable information via contactless RFID technology to prevent unwanted access to the valuable information.

### SUMMARY OF THE INVENTION

The present invention provides portable enclosures with hinged slide or flapped openings capable of containing several radio frequency identification (contactless RFID) tags, cards and chips, memories and antennae embedded in other devices. The portable enclosure shields the contactless cards or devices from electromagnetic RF signals trying to activate and read the RFID tags. RFID devices include contactless smart cards and other similar devices that may be used for payment and identification. Made from a variety of materials, including plastic, rubber, metal, leather, vinyl, fabric, or other material capable of withstanding use, weather, and surrounding environment, with a metallic substrate embedded in the material used. The metal can consist of copper, silver, aluminum, tin, or any other metal capable of attenuating completely the wavelength necessary to reach and activate the embedded RFI Tag. The metal can be in a weave, solid, or any structure capable of necessary shield.

The invention protects information encoded on an RFI tag embedded in an item such as a credit card or passport, but is not limited to them. It consists of 2 basic layers which completely surround the item containing the RFI Tag: a protective inner layer of metal that keeps signals from hitting RFI Tag and thus keeps that Tag from responding to errant or malicious signals and releasing information to someone to which the owner has not agreed to give the information and an outer layer of material creating a physical barrier against the elements and serves a decorative function.

The present invention provides two layer portable enclosures. The inner layer is a protective layer of metal that keeps signals from hitting the RFID tags, chips, memories and antennae. The outer layer is a physical barrier against the elements and serves a decorative function.

In one embodiment, the portable enclosure of the present invention is a six sided enclosure with a hinged and/or slide opening. One or more RFID contactless tags, cards, memories and antenna are embedded in other portable devices are contained within the enclosure. The inner layer metal is preferably, but not limited to, copper, silver, aluminum, tin or any other metal capable of attenuating completely the wavelength necessary to reach and activate the embedded RFID contactless devices. The metal may be in a weave, solid, knit or woven fabric of metal wires or any other structure capable of the necessary shielding. The outer layer is preferably, but not limited to, plastic, rubber, metal, leather, vinyl, fabric, or other materials capable of withstanding use, weather, and the surrounding environment. The inner layer may be embedded within the outer layer.

The present invention is particularly useful for credit cards and passports, but is not limited to these devices. The two layers of the portable enclosure completely surround the contactless RFID devices. The protective inner layer prevents signals from hitting the RFID devices. The lack of signals prevents the RFID tag from responding to errant or malicious signals and thus releasing information to a non-authorized individual.

The present EM and RF shielding apparatus includes a bottom half of an enclosure, a top half of an enclosure, a connection between the bottom half and the top half, an enclosure space between the bottom half and the top half for holding enclosed contactless RFID devices, shielding on inner surfaces or within the bottom half and the top half for completely attenuating wavelengths associated with the enclosed contactless RFID devices.

The shielding on the bottom half and the top half overlaps. The shielding is a metal knit weave, solid metal, particulate matter, or knit fabric. The shielding is copper, silver, aluminum or tin. The bottom half and the top half may be generally rectangular with four side walls. The bottom half and the top half are plastic, rubber, metal, leather, vinyl or fabric.

The connection between the bottom half and the top half may be one or more hinges between the bottom half and the top half for opening and closing the apparatus, and one or more latches between the bottom half and the top half for securing the bottom half to the top half.

Alternatively, the connection between the bottom half and the top half may be outwardly re-entrant shielded edges on the bottom half and complementary inwardly re-entrant shielded edges on the top half. The top half is opened by sliding the top half relative to the bottom half.

In another embodiment, the connection between the bottom half and the top half may be recessed walls on the bottom half and complementary walls on the top half.

In another embodiment, an RFID shielding apparatus includes a bottom half of an enclosure, a top half of an enclosure, an overlapping connection between the bottom half and the top half, an enclosure space between the bottom half and the top half for holding enclosed RFID devices, shielding on inner surfaces or within the bottom half and the top half for completely attenuating wavelengths associated with the enclosed RFID devices, a shielded access covering an access opening in the top half, lugs on an underside of the top half for sliding the shielded access from an initial position to an open position and back to an initial position. The shielding on the bottom half and the top half and on the access opening and top overlap. The device may also include ridges on the shielded access for improving grip.

The connection between the bottom half and the top half may include one or more hinges between the bottom half and the top half for opening and closing the apparatus, and one or more latches between the bottom half and the top half for securing the bottom half to the top half.

One embodiment of the invention provides a wallet with a shield at least around the card receiving section. Preferably, the entire wallet is shielded. Shielding extends around a front, a bottom, a back, a hinge and a flap, as well as on the gusseted flexible sides.

These and further and other objects and features of the invention are apparent in the disclosure, which includes the above and ongoing written specification, with the drawings.

### BRIEF DESCRIPTION OF THE DRAWINGS

FIG. 1 is a perspective view of a first portable enclosure.

FIG. 2 is a cross section of a first portable enclosure.

FIG. 3 is an open top view of an open first portable enclosure.

FIG. 4 is perspective view of a second portable enclosure.

FIG. 5 is a cross section of a top of the second portable enclosure.

FIG. 6 is a cross section of a bottom of the second portable enclosure.

FIG. 7 is perspective view of a third portable enclosure.

FIGS. 8A and 8B are a side and end detail views of a top access in the third portable enclosure.

FIG. 9 is a perspective view of an open fourth portable enclosure.

FIG. 10 is a cross section of the base of the fourth portable enclosure.

FIG. 11 is a cross section of the cap of the fourth portable enclosure.

FIG. 12 is a perspective view of an EM/RF shielded wallet for holding contactless smart cards.

### DETAILED DESCRIPTION OF THE PREFERRED EMBODIMENTS

Thee present invention is a portable enclosure with shielding completely surrounding the radio frequency identification (“RFID”) devices and openings having overlapping RFID shielding.

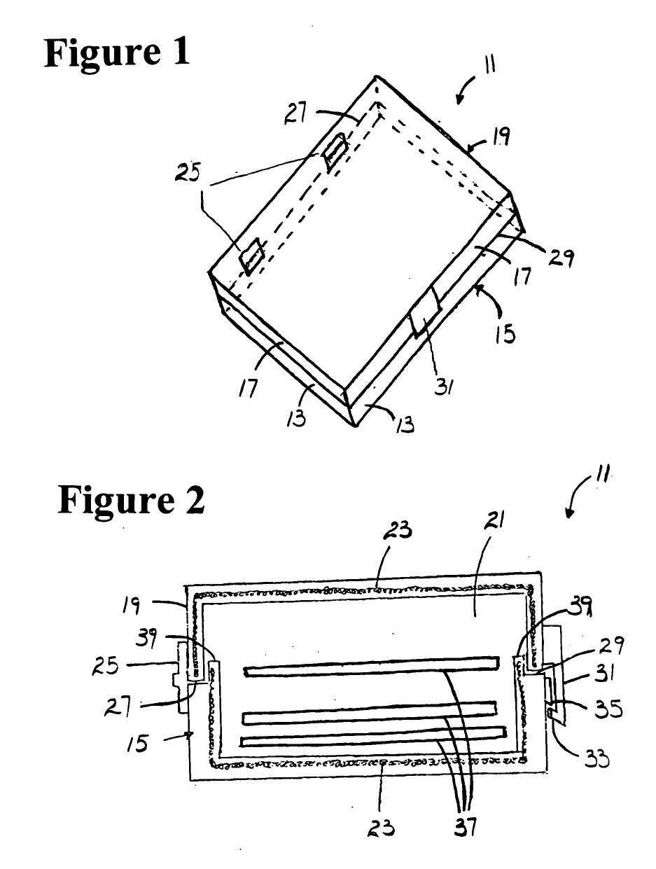

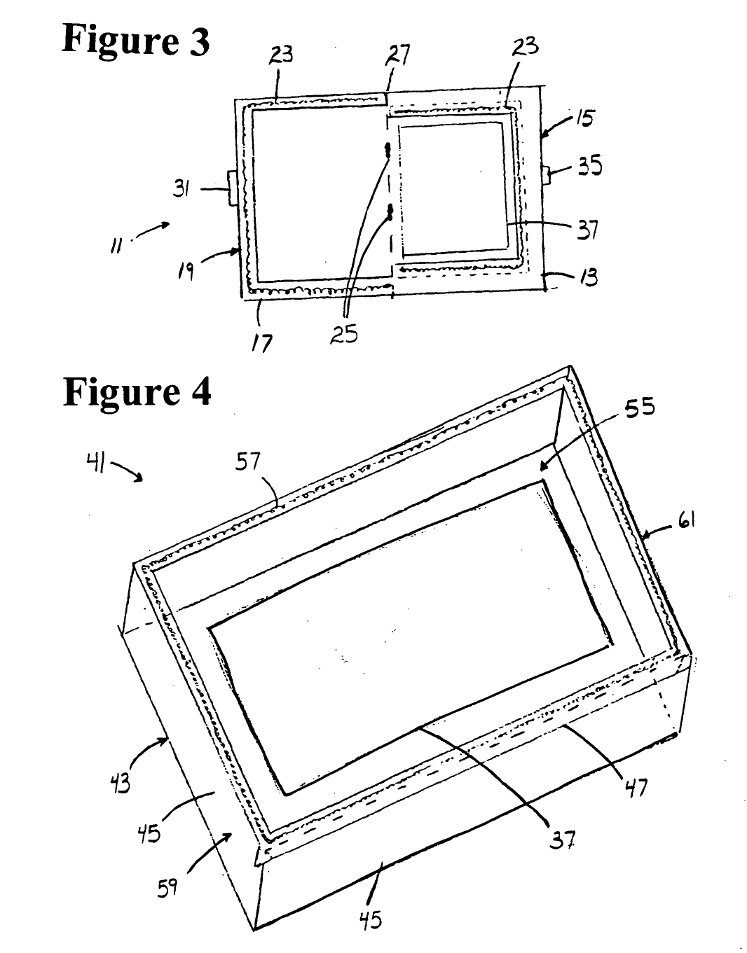

FIGS. 1-3 show a first embodiment of a portable enclosure 11. The device 11 has a four-walled 13 flat base 15 and a four-walled 17 flat cover 19. The flat base 15 and the flat cover 19 fit together to create an enclosed space 21. Shielding 23 is located on an inner surface of or within the flat base 15 and the flat cover 19. The shielding 23 is preferably, but not limited to, a metal wire knit or weave, solid metal, particulate matter, knit fabric or other material that may work by just weakening or attenuating the wavelengths associated with enclosed RFID devices. The shielding 23 creates a complete Faraday cage when closed. Base walls 13 overlap 39 with top walls 17. The base 15 and the cover 19 are hinged together with one or more hinges 25 along corresponding edges 27 of the base 15 and the cover 19. The opposite edges 29 of the base 15 and the cover 19 holds a slightly flexible latch 31 that snaps into engagement when closed. The latch 31 has a protrusion 33 that snaps over a catch 35. Unfastening the latch 31 requires intentional lifting or dislodging of the latch 31 before opening the device 11. One or more devices 37 with embedded RFID tags are stored within the enclosed space 21.

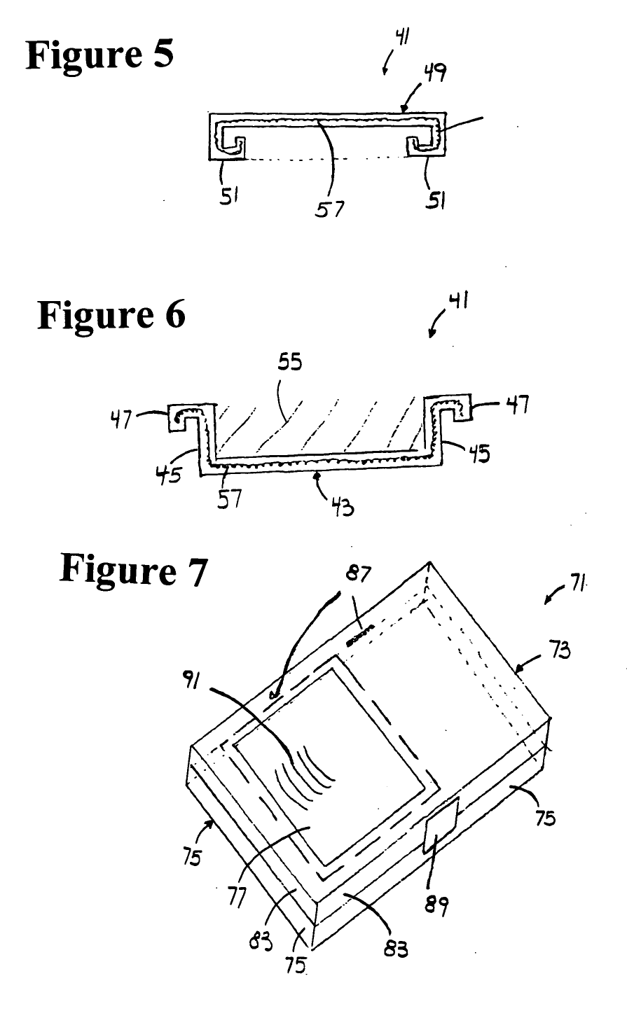

FIGS. 4-6 show a second embodiment of a portable enclosure 41. A base 43 has four walls 45 with outwardly re-entrant shielded edges 47. A top 49 has complementary inwardly re-entrant shielded edges 51. The top 49 is slid along the base 43 to retrieve or place devices 37 with embedded RFID within an enclosed space 55. The top 49 may be slid either towards a front 59 or a rear 61 of the base 43 to open the device 41. Shielding 57 is located on an inner surface or throughout the top 49 and the base 43. When the device 41 is closed a complete Faraday cage is created and no RFID information is transmitted outside the device 41.

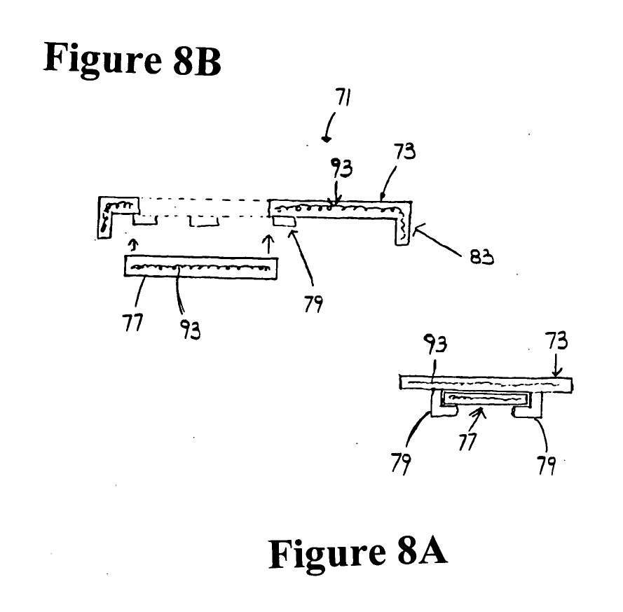

FIGS. 7-8 show a third embodiment of a portable enclosure 71. A shielded top 73 fits onto a shielded base 75. A shielded access 77 slides along lugs 79 under the top 73 to open an access opening 81. The shielded access 77 is slid back to an initial position to close the device 71. The access opening 81 allows omni directional reading of an RFID tag. Shielded side walls 83 of the top 73 overlap shielded side walls 85 of the base 75. The top 73 is hinged with a hinge 87 and latch 89 closure similar to the first embodiment. The hinging allows insertion and withdrawal of devices with embedded RFID tags. Ridges 91 on the shielded access 77 provide additional grip for a user's fingers. Shielding 93 prevents transmission of RFID information when the device 71 is closed. The device 71 is easy to open and prevents potential eavesdropping.

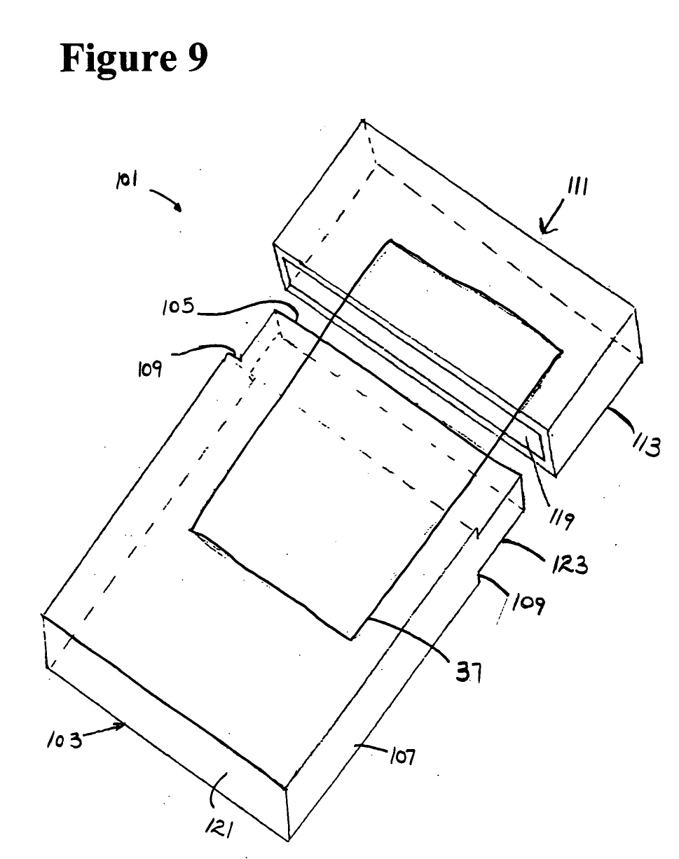

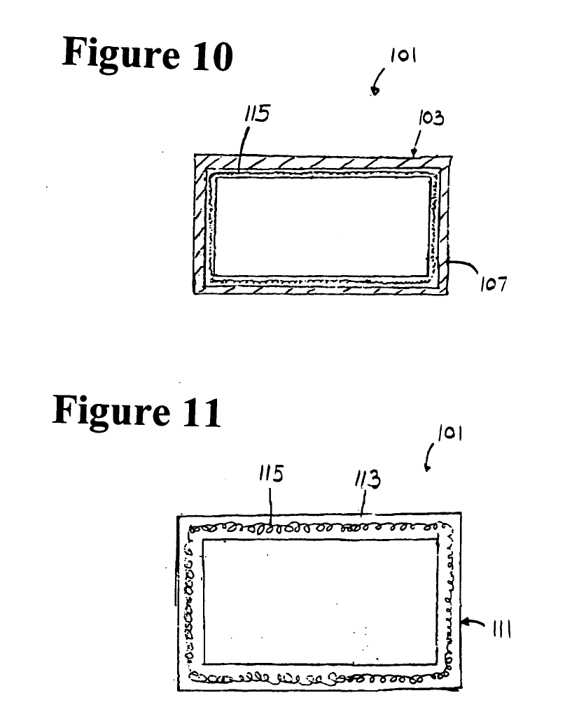

FIGS. 9-11 show a fourth embodiment of a portable enclosure 101. The device 101 includes a case 103 with a base 121, side walls 107 and an open end 105. Upper walls 123 on the open end 105 of the case 103 are recessed 109. A cover 111 has walls 113 that fit in the recesses 109 on the case 103. Shielding 115 in the side walls 107, 113 creates a complete Faraday cage by overlapping. Devices 37 with embedded RFID tags are held within an opening 119 created by the interaction of the case 103 and cover 111.

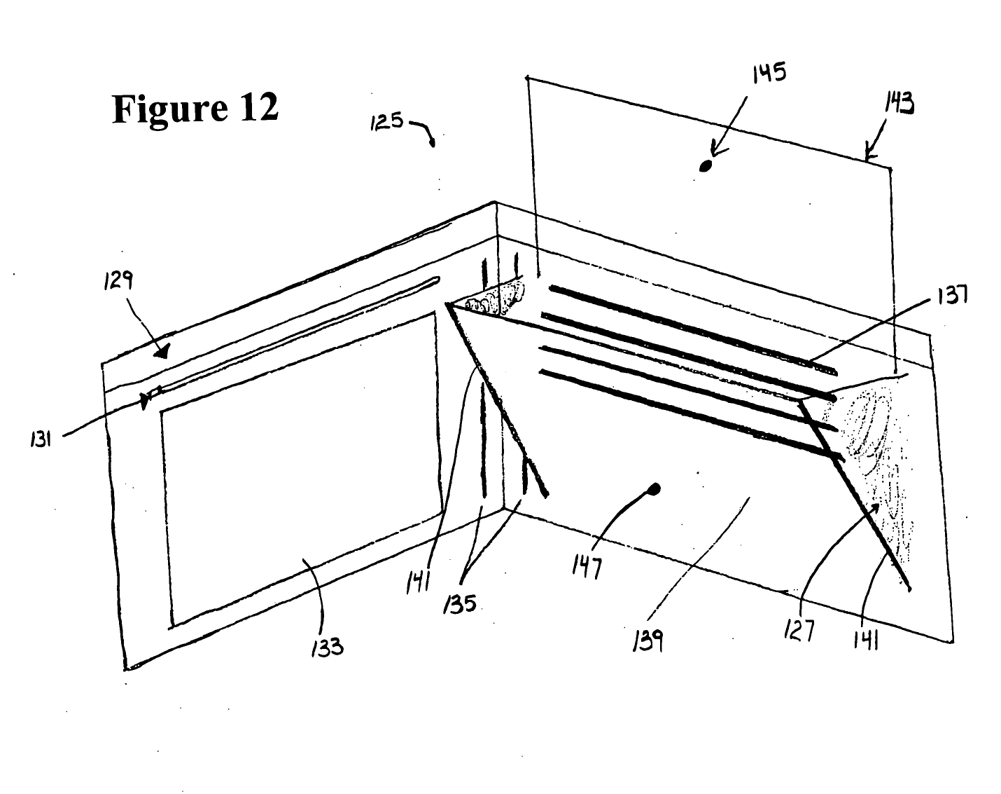

FIG. 12 shows a perspective view of an EM/RF shielded wallet 125 for holding contactless smart cards or other similar devices. The entire wallet 125 has shielding 127 between materials or is made of shielded materials. The wallet 125 has one or more openings for money 129, an opening 131 to hold identification, and a clear plastic window 133 for viewing identification. Other openings 135 may be provided. Devices 37 with RFID are placed in slots 137 within the wallet 125. A bottom flap 139 closes over the devices 37 in the slots 137 by folding or compressing gusseted flexible sides 141. A top flap 143 folds down over the bottom flap 139 to create overlapping shielding. A top snap 145 is secured to a bottom snap 147 to hold the top flap 143 in contact with the bottom flap 139. Other similar closure devices may be used.

While the invention has been described with reference to specific embodiments, modifications and variations of the invention may be constructed without departing from the scope of the invention.

1. An RFID shielding apparatus comprising:
a bottom half of an enclosure,
a top half of an enclosure,
a connection between the bottom half and the top half,
an enclosure space between the bottom half and the top half for holding enclosed RFID devices,
shielding on inner surfaces or within the bottom half and the top half for completely attenuating wavelengths associated with the enclosed RFID devices, and
wherein shielding on the bottom half and the top half overlaps.

2. The apparatus of claim 1, wherein the shielding is a metal weave, solid metal, particulate matter, or knit fabric.

3. The apparatus of claim 1, wherein the bottom half and the top half are generally rectangular with four side walls.

4. The apparatus of claim 1, wherein the connection between the bottom half and the top half further comprises one or more hinges between the bottom half and the top half for opening and closing the apparatus, and one or more latches between the bottom half and the top half for securing the bottom half to the top half.

5. The apparatus of claim 1, wherein the connection between the bottom half and the top half further comprises outwardly re-entrant shielded edges on the bottom half and complementary inwardly re-entrant shielded edges on the top half.

6. The apparatus of claim 5, wherein the top half is removed by sliding the top half relative to the bottom half.

7. The apparatus of claim 1, wherein the connection between the bottom half and the top half further comprises recessed walls on the bottom half and complementary walls on the top half.

8. The apparatus of claim 1, wherein the shielding is copper, silver, aluminum or tin.

9. The apparatus of claim 1, wherein the bottom half and the top half are plastic, rubber, metal, leather, vinyl or fabric.

10. An RFID shielding apparatus comprising:
a bottom half of an enclosure,
a top half of an enclosure,
a connection between the bottom half and the top half,
an enclosure space between the bottom half and the top half for holding enclosed RFID devices,
shielding on inner surfaces or within the bottom half and the top half for completely attenuating wavelengths associated with the enclosed RFID devices,
a shielded access covering an access opening in the top half,
lugs on an underside of the top half for sliding the shielded access from an initial position to an open position and back to an initial position, and
wherein shielding on the bottom half and the top half overlaps.

11. The apparatus of claim 10, further comprising ridges on the shielded access for improving grip.

12. The apparatus of claim 1, wherein the shielding is a metal weave, solid metal, particulate matter, or knit fabric.

13. The apparatus of claim 1, wherein the bottom half and the top half are generally rectangular with four side walls.

14. The apparatus of claim 1, wherein the connection between the bottom half and the top half further comprises one or more hinges between the bottom half and the top half for opening and closing the apparatus, and one or more latches between the bottom half and the top half for securing the bottom half to the top half.

15. The apparatus of claim 1, wherein the shielding is copper, silver, aluminum or tin.

16. The apparatus of claim 1, wherein the bottom half and the top half are plastic, rubber, metal, leather, vinyl or fabric.

17. An RFID shielding apparatus comprising:
a bottom half of an enclosure,
a top half of an enclosure,
a connection between the bottom half and the top half,
an enclosure space between the bottom half and the top half for holding enclosed RFID devices,
one or more hinges between the bottom half and the top half for opening and closing the apparatus,
one or more latches between the bottom half and the top half for securing the bottom half to the top half,
shielding on inner surfaces or within the bottom half and the top half for completely attenuating wavelengths associated with the enclosed RFID devices, and
wherein shielding on the bottom half and the top half overlaps.

18. Contactless radio frequency electromagnetic inductance device shielding container apparatus comprising:
a top, a base and sides connecting the top and base,
the top, the base and the sides having shielding metal elements embedded therein,
the shielding in the sides overlapping for attenuating radio frequency electromagnetic energy impinging on the top, the base or the sides.

19. The apparatus of claim 18, wherein the top, the base and the sides are rectangular and wherein portions of the shielding in the sides remote from the top and the base overlap in surrounding relationships when the container is closed.

20. The apparatus of claim 19, wherein portions of the sides remote from the top and the base are joined with hinges along first sides and are joined with latches along second opposite sides.

21. The apparatus of claim 18, wherein side walls on the top are relatively short and opposite side walls on the top and shielding within the opposite side walls are reentrantly bent in first opposite senses of direction relative to a center of the container and wherein side walls on the base are relatively tall and upper portions of opposite side walls on the base and shielding within the opposite side walls are reentrantly bent in second opposite senses of direction relative to the center of the container for receiving the opposite side walls on the top.

22. The apparatus of claim 18, wherein the top has an access opening with downward and inward lugs extending from the top at positions spaced downward from the opening and further comprising a sliding cover with shielding in the cover for selectively opening and closing the access opening to remove and replace contactless devices through the access opening.

23. The apparatus of claim 18, wherein the container is deep and the sidewalls are arranged in a rectangular manner, sidewalls connected to the top are relatively short and side walls connected to the base are relatively long and wherein the top fits over complementary shielded surfaces on the base for securing the top to the base.

24. Contactless radio frequency electromagnetic inductance device shielding wallet comprising:
one or more openings for holding currency,
one or more openings for holding identification,
one or more slots for holding devices with RFID,
a bottom flap covering the one or more slots,
a top flap covering the one or more slots and overlapping with the bottom flap,
a closure device for securing the top flap to the bottom flap, and
wherein the wallet is made of shielding material or has shielding between layers of material.
